(19) United States
(12) Patent Application Publication
(10) Pub. No.: US 2018/0083965 A1
(43) Pub. Date: Mar. 22, 2018

(54) Method and Apparatus for Managing Authentication in a Decentralized or Distributed Network of Cyber- Physical Systems

(71) Applicant: William Curtis Donovan, Portland, ME (US)

(72) Inventor: William Curtis Donovan, Portland, ME (US)

(73) Assignee: William Curtis Donovan, Portland, ME (US)

(21) Appl. No.: 15/267,292

(22) Filed: Sep. 16, 2016

(51) Int. Cl. H04L 29/06

(52) U.S. Cl. CPC H04L 63/0884; H04L 2463/101

(57) ABSTRACT

A Method and Apparatus is disclosed for Multi-Agent Authentication in a decentralized or distributed network of Cyber-Physical Systems for the purpose of enhancing the overall Utility of Agency and Ownership. This Apparatus consists of an End Agent Authentication Device (an “Authenticator”) that is necessary in all authentication processes, and this invention defines an End Agent State Machine, and a set of nine distributed authentication processes that are enabled by this Authenticator. This Method acknowledged the ability for an Authenticated End Agent to have its Semantic Data Model managed by its Authenticated Owner. This Method enhances security and reduces complexity by allowing the Authenticator to execute these nine processes in both decentralized or distributed network configurations.

An Example of this Method and Apparatus in use is a scenario with an internet-connected non-Authenticator Device (a “Non-Authenticator End Agent”) in a commercial/retail location whereby the Owner (an “Owner Interested Agent”) of that Device, very likely the Owner of the commercial/retail location, has Authenticated that Device using their Authenticator (an “Authenticator End Agent”) on a Decentralized or Distributed Network. In this example, the owner has pre-defined the Semantics of that Device's End Agent Sub-Class(es), State Machine Sub-Classes (if any), and its Classes and Attributed of Service to commercial/retail customers in the Device's “Semantic Data Model”. As a function of that Semantic Data Model, the owner has defined the Sub-Classes of commercial/retail customers (“Non-Owner Interested Agents”) who have the Permission to Authenticate with the internet-connected Device, be served by the Device, and in certain circumstances even Control the Device, within the Parameters set by the Owner of that Device in the Device's Semantic Data Model. When this Non-Owner Authentication occurs, an Owner-defined limited-to-significant set of capabilities are made available by the End Agent to the Non-Owner Interested Agent without compromising the notion in the Semantic Data Model of Ownership, Control and/or Authentication.

### CROSS REFERENCE TO PROVISIONAL APPLICATION

This application claims all benefit, including priority, of U.S. Provisional Patent Application Ser. No. 62/219,581, filed on Sep. 16, 2015 and entitled “METHOD AND WEARABLE APPARATUS TO SENSE, DIRECT, AND MEASURE BODY MOVEMENT AND BIOMETRIC DATA, AND TO PROVIDE CLOUD-BASED, REAL-TIME AUTOMATED COACHING, COLLABORATION, AND COMPETITION IN A SINGLE NETWORK, the contents of which is incorporated herein by reference, in its entirety.

### BACKGROUND OF INVENTION

This invention relates to managing and maintaining trust and authentication in a Decentralized or Distributed Network of Cyber Physical Systems.

Today, Cyber Physical Systems have three primary areas of utilization, Industrial, Smart City, and Consumer. “industrial” applications of utility include, for example. The elements of an automated vehicle assembly line, or the tracking material in a supply chain using radio frequency technology (RFID). “Smart City” application include, for example internet connected utility boxes. “Consumer” applications of utility include internet connected home devices and appliances such as Smart TV's, light bulbs, doors, speaker systems, etc. In totality, the devices in these Cyber Physical Systems are known as “Internet of Things” or “IOT” devices. In the prior art, semantics, utility, trust, permissions and services in Industrial, Smart City and Smart Home Cyber-Physical Systems are always centrally managed. As a result of the centrally managed Cyber-Physical Systems, one never has full ownerships of an internet connected device if they wish to allow others to connect to their device as well. The rights to the internet connected device must be fully granted to whomever is connected to the device. This presents serious commercial and security concerns.

As the number of individuals and enterprises grow that are interested in Cyber Physical Systems and networks of Internet of Things, maintaining broad interoperability requires exponentially increasing semantic orchestration even as centralized administration becomes exponentially complex. Decentralization and/or distribution are necessary strategies to handle the new scope and quantity of these types of Cyber Physical Systems. This is especially true as the lines between Industrial, Smart City, and Consumer blur into supersets of Cyber Physical System and IOT applications that cut across Industry, Municipality and Consumer.

Multiple layers of ownership exist between Industry, Smart City and Consumer, that require collaboration between agents across individually owned devices that must be manages at different times by different agents, all agents are interested in the outcome of the superset of the Cyber Physical Systems (plural) that are integrated. As the number of agents and connected devices reaches into the millions, hundred millions, billions or hundreds of billions, managements must be left to the owners unless the owners designate alternative managers in either a decentralized or distributed strategy. Trust and Authentication are necessary in either a decentralized or distributed form of such a network.

This invention enables non-centrally managed networks of Cyber Physical Systems, to establish and maintain trust in a “Network of Networks” between people and devices without centralized authority. Such a non-centrally managed network can be considered “decentralized” or “distributed.” Decentralized networks allow utility, trust, permissions and services to be managed independent of a central authority, although a central authority may exist to design and maintain the Network Semantics. Distributed networks allow semantics, utility, trust, permissions and services to be managed without any central authority.

No prior are addresses the capability to manage semantics, utility, trust, permissions and services in a Cyber Physical System that is either “decentralized” or “distributed.”

This invention addresses that capability, and enables new commercial applications of Cyber Physical Systems by enhancing interoperability of disparate network nodes while reducing the need for centrally administering those same network nodes, even as the size and complexity of those networks grows exponentially.

The advantages of such a massively complex Network of Cyber Physical Systems (of IOT Devices) are significant—such a Network could be centrally provisioned as a Service in the Cloud to provide a platform for cyber security, for shared cost, for new business ventures, and for the division of roles in a value-creating transactional process, even as trust management remains decentralized. An example of such a “Network of Networks” is Social Network”, Trust is decentralized between individuals, not centrally by the Social Network Owner and/or Operator. Trust is established between individuals when they “friend” each other, which gives each other access to certain network content and certain collaboration tools that produce certain transactions. In the early days of Social Networks, certain trust vehicle were quasi-centralized—for example, an individual could not be considered “Interested” in the network if they did not hold an email address of a particular domain. The assumption was that the domain “interest” was guaranteed by the domain owner, for example a University. Even then, one could not become a “Friend” with another peer if they did not take the specific action. Some Social Networks have eliminated such centralized control, but almost all Social Networks have maintained tools for managing Trust at the individual level based on the mutual “interest” of the agents involved. There are some exceptions to this rule, such as Craigslist.org, but even these have moved to enhance the ability to control Trust after suffering scandals in the media due to salacious utilization by network agents.

Another example of a Network of Networks is the Internet itself, which has no centralized Network Owner and/or Operator therefore is truly “distributed.” In this case, Trust is established in a variety of ways. In the early days of the internet, this lack of a central authority produced chaos. Frameworks and confederations were developed to enhance the distribution of Trust in a truly “distributed” and “organic” Network of Networks. One of the most successful frameworks is the Semantic Web, developed by the World Wide Web, developed by the World Wide Web Consortium (W3C). According to the WC3, “The Semantic Web provides a common framework that allows data to be shared and reused across application, enterprise, and community boundaries.” (SITE) in 2013, more than four million Web domains contains Semantic Web markup (SITE). As the bulk of internet content moves towards just a few major Social Media and Trading platforms (eg. Facebook, Twitter, Instagram, Amazon, Google, etc.), the application of Trust within the Semantic Web grows in its importance. In the Semantic Web, once Trust is established, interoperability becomes possible: Content can be transactionally shared/distributed between platforms without centralized management—just as importantly, in the Owners, Producers, Distributors, and Consumers of that Content without central management.

An evolution of the Semantic Web, and another example of a “distributed” Network of Networks without any central authority, is BitCoin and its Blockchain technology. Blockchain refers to a process in which there is a continuously growing digital list of blocks (transactions) that are shared and distributed among a network of computers. This technology allows for a de-centralized network of transactions to occur, utilizing the nodes as the authenticators of trust. Blockchain technology allows for two individuals to communicate through the internet without the interference of a third party. Bitcoin is a primary use of the Blockchain architecture because it provides an open, decentralized database for value transactions. This allows for a community if users to directly be involved in a transaction, making it unnecessary for a third party to be involved in a transfer. Facebook is an example of a centralized network. In this invention, the Authenticator Device would act as the method of authentication rather than a clearing house.

### SUMMER OF INVENTION

The present invention provides a novel method and apparatus for establishing and maintaining Trust through Authentication in a decentralized or distributed Network of two classes of agents: Devices/Apparatuses (classified as “End Agents”) and non-Device/non-Apparatus agents (classified as “Interested Agents”), comprising integrated domains and sub-domains of “Cyber Physical Systems”—such a “Network of Networks” can be owned and operated as a Platform, or have no individual owner, but in either case its management is explicitly decentralized and therefore said to be “decentralized” or “distributed.” In such a decentralized or distributed Network, no central manager is able to override or gain access to the Semantic Data Model for any End Agent or Interested Agent without permission, and in fact no central manager may even exist (See FIG. 1).

The method presented in this invention includes 1) the definition of a Semantic Data Model for Agency sub-classification, and for End Agent services classification and sub-classification (See FIG. 2, FIG. 3 & FIG. 6), 2) the definition of an End Agent State Machine (See FIG. 4, FIG. 7, & FIG. 8), and 3) the definition of a set of nine distributed authentication processes enabled by an Authenticator Apparatus (See FIG. 4). Taken together, these three elements enable a suite of commercial applications that require Trust when management of Cyber Physical Systems is decentralized and distributed, that were not possible in the prior art.

This invention defines a Semantic Data Model for a Distributed Network of Cyber Physical Systems. This invention only classifies two classes of Agent: Devices/Apparatuses (classified as “End Agents”) and non-Device/non-Apparatus agents (classified as “Interested Agents”). This invention classifies the relationship between End Agents and Interested Agents as a form of Utility.

As a function of defining Utility between Interested Agents and End Agents, this Semantic Data Model sub-classifies a sub-class of an Interested Agent as “Owning” (an “Owner” of a device/apparatus End Agent). The Owner of the End Agent is able to further define Utility of the End Agent by defining additional elements of the End Agent's Semantic Data Model.

As a function of defining the End Agent Utility, this Semantic Data Model allows for an End Agent Owner to define an infinite number of classes of Service that the End Agent provides other End Agents and Interested Agents. The End Agent Owner is also capable of defining the Semantics and Triggers of those services.

This invention's Semantic Data Model defines the sub-classification(s) of the End Agent on the basis of the Service(s) that the End Agent is able to provide other Interested Agents and/or other End Agents. Depending on the End Agent Service(s) that the End Agent is capable of providing, the End Agent Owner can sub-classify the End Agent with an infinite number of End Agent sub-classifications.

As a function of defining End Agent Utility, this invention's Semantic Data Model classifies a class of End Agent Service as “Authentication.” When triggered, this Authentication service authenticated other End Agents.

This invention sub-classifies a sub-class of an End Agent as “Authenticating” (an “Authenticator” apparatus/device) that provides authentication services to other Agents. Only End Agents that are capable of providing Authentication Services may be sub-classified as Authenticators.

An Authenticator is a Digital Apparatus (End Agent) that is capable of providing Authentication Services to other Agents on behalf of its Owner Interested Agent. An Authenticator is capable of inputting data and exporting data. An Authenticator is capable of recording data involving Authentication of End Agents that it has Authenticated. An Authenticator is capable or recording data involving Transfer of Authentication of End Agents that it has Authenticated to another Authenticator (either of the same Owner or a different Owner). An Authenticator is capable of recording data involving De-Authentication of other End Agents or itself. An Authenticator is capable of ensuring that only its Owner is able to Utilize it, unless the Owner Distributes the Authenticator on some Basis, such a period of time or until some later event, or until the Owner recalls the Authenticator. This invention does not specify the form of access assurance an Authenticator would Utilize, but examples could include Passcode(s). Security Question(s), Biometric(s), Physical Key(s), etc. This invention does not specify the form factor of an Authenticator, but for example it could be a fixed/stationary device, it would be a mobile device such as a Smart Phone, or it could be a wearable device such as a Smart Watch, or it could be a biologically-embedded device. Because it must store Authentication data, an Authenticator cannot merely be a biometric, although an Authenticator can use one or more biometrics to ensure Authenticator security.

When End Agents are originally authenticated by an Authenticator, ownership of the newly authenticated End Agent is inherited from the ownership of the Authenticator. When End Agents are authenticated by Authenticators that did not originally Authenticate the End Agent, Ownership of the authenticated End Agent is maintained by original owner.

This invention does not specify the method or mechanism of authentication in the Authentication Service—only that the method ensures that Trust is establishes and that the Authenticator is physically present with the authenticated End Agent and subsequently capable of uniquely authenticating with it. However, a list of authentication examples could include: passcode, barcode scan, challenge questions, etc. This invention does not specify the method or mechanism of cryptology provided during or after the Authentication Service that ensures the security and quality of End Agent and/or Interested Agent Utility on the Decentralized or Distributed network.

As a function of defining the End Agent Utility, this Semantic Data Model allows for an infinite number of sub-classes of Interested Agents, that can authenticate with the End Agent, to be defined by the End Agent Owner when the End Agent is in the appropriate state.

As a function of defining Utility between End Agents and Interested Agents, this Semantic Data Model allows for Interested Agents to sub-classify themselves in an infinite number of sub-classifications, and to authentically associated those sub-classifications with their Authenticator, or some other form of authentication other than their Authenticator. This invention does not specify the method or mechanism of non-authenticator End Agent authentication that the Interested Agent may use to identify their sub-classification to an End Agent, however, examples could include Wearable Near Frequency Communication, Magnetic Strip, Passcode, Unique Key, etc.

This invention does not specify any additional details of the Semantic Data Model in reference to the content of any services other than Authentication Service. However, examples of such Semantic Content in a Non-Authentication Service could include (prioritization, channel, design, etc., timing, etc., style tags (color/audio), etc., biofeedback., motion).

This invention defines an End Agent State Machine. This End Agent State Machine sis classified with three states: Non-Utilized, Utilized-Resting, and Utilized-Serving. The End Agent in the Semantic Data Model, including both Authenticators and non-Authenticators. An End Agent enters the “Non-Utilized” State when it is Pre-Registered by an Authenticator. Pre-Registration details are confirmed by the Authenticator Owner. An End Agent cannot provide any service in “Non-Utilized” state. An End Agent moves from “Non-Utilized” to “Utilized-Resting” when it is Authenticated by an Authenticator and its Ownership is assigned. An End Agent cannot provide any service in this state. An End Agent Owner determines the semantic elements that trigger the End Agent to provide when the End Agent is in “Utilized-Resting” state. Upon triggering (as defined by the Owner in the Semantic Data Model of the End Agent), the End Agent moves from “Utilized-Resting” to “Utilized-Serving,” and provides its service, until it is triggered to return to “Utilized Resting.” An End Agent's Semantic Data Model cannot be altered when it is in this “Utilized-Serving” state. If an End Agent is not in any of these three states, the End Agent cannot have representation of its Agency in the Network.

Each State Class in the End Agent State Machine can be further sub-classified with an infinite number of End Agent State Sub-Classes, and the semantic service, content and trigger elements that move the End Agent from Sub-State to Sub-State can be further defined by the End Agent Owner.

Taken together, the above-defined Semantic Data Model and above-defined End Agent State Machine enable a set of nine distributed authentication processes enabled by an Authenticator Apparatus in Network of Cyber Physical Systems. They are:
1) Authenticate New Authenticator for the purpose of transferring the Authenticator's Ownership to another Interested Agent.
2) Authentication of new End Item.
3) Distribution of Authentication while inheriting Ownership.
4) Authentication of Transfer of End Item Ownership.
5) Transfer of End Item Authentication Control from one Authenticator to another Authenticator, all Owner by the same Interested Agent.
6) De-Authentication of an End Agent with an Authenticator.
7) Destruction of an End Agent with an Authenticator.
8) Destroy last Authenticator without additional Authenticator.
9) Non-Owner End Agent Authentication for the provisioning of Owner defined Non-Authentication End Agent Services.

### BRIEF DESCRIPTION OF DRAWINGS

FIG. 1 shows three distinct types of Authentication Network Configurations: Centralized 001, Decentralized 006, and Distributed 028.

FIG. 2 shows two distinct authentication processes (101 and 102) showing the interplay between multiple Interested Agents, multiple Authenticators, and a non-Authenticator End Agent, with Utility Services, Ownership and Semantic Data Model management throughout.

FIG. 3 shows the portion of the Semantic Data Model of Devices/Apparatuses (Classified as “Ed Agents” or by the nomenclature “Ae”) that defines their Relationship (or “Utility”) with non-Device/non-Apparatus agents (Classified as “Interested Agents” or by the nomenclature Ai) in an example Network of Cyber Physical Systems.

FIG. 4 shows an End Agent State Machine for both Authenticators and Non-Authenticators that is a representation of the minimum possible states and transitions of any End Agent in this invention.

FIGS. 5.1, 5.2, 5.3, 5.4, 5.5, 5.6, 5.7, and 5.8 show how the Semantic Data Model of Agency between Owner and Non-Owner Interested Agents, and Authenticator and Non-Authenticated End Agents, and Sub-Classifications of Non-Owner Interested Agents, and the End Agent State Machine, and End Agent Authentication Services and Triggers and other Semantic Data, come together in a set of integrated and distributed Authentication processes that enable a Network of Cyber Physical Systems.

FIG. 6 shows how a Network of Cyber Physical Systems with distributed Trust between Agents enables an Interested Agent to Authenticate with, and be served by, an End Agent that is Owned by another Interested Agent.

FIG. 7 shows the relationship between the End Agent State Machine in a Pre-Registration and Authentication, and an Authentication and Trigger set of Utilize cases.

FIG. 8 shows how a Network of Cyber Physical Systems can have infinitely defined State Machine Sub-Classifications based on the End Agent State Machine defined in this Invention.

### DETAILED DESCRIPTION OF DRAWINGS

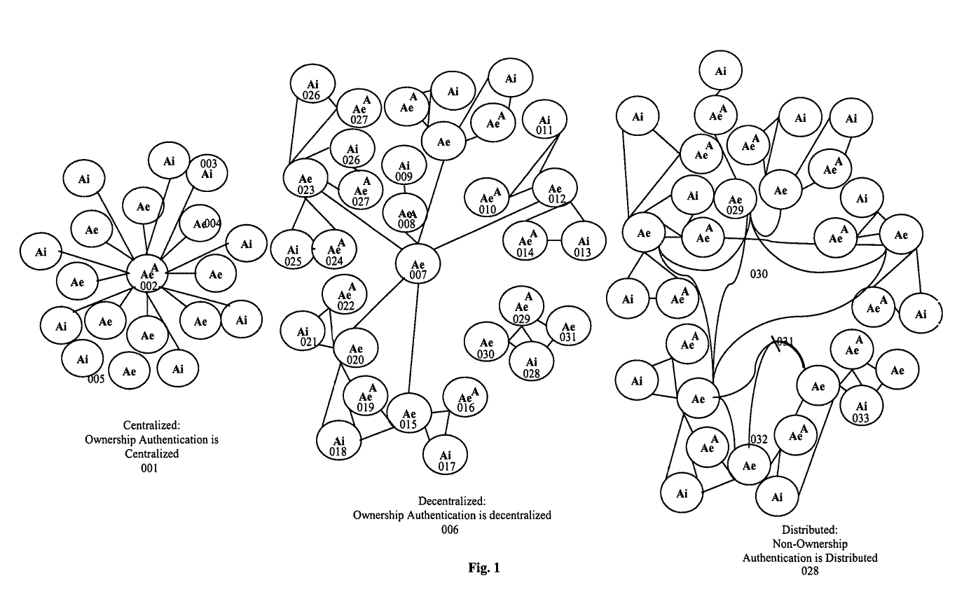

FIG. 1 shows three distinct types of Authentication Network Configurations: Centralized 001, Decentralized 006, and Distributed 028.

In a Centralized 001 Authentication Network, the Ownership, and Semantic Data Model Control, of End Agents (such as 004) are authenticated by a Central Server 002 by their respective Owner (for example Interested Agent 003). The Ownership Relationship and Utility are represented Centrally on the Server 002. In this Configuration, Agents that do not connect to the Network cannot be Authenticated by any Third Party Agent (represented by 005), even as, in this Configuration, the Owner of the Central Authenticator 002 can hypothetically gain access to any Authenticated End Agent on the Network because in a sense the Owner of the Network owns all of the End Agents on the Network.

In a Decentralized Authentication Network 006, the Ownership, and the Semantic Data Control, of End Agents (such as 012) are Authenticated by an Authenticator (such as 010) by their respective Owner (for example Interested Agent 011) without the aid of a Central Server. The Owner's Authenticator 010 maintains a record of the Owner's Ownership locally, and does not communicate Authentication data to a Central Server 007. The Authenticated End Agent broadcasts certain limited data points of their Ownership, their Authentication, and their Semantic Data Model, to a Central Server 007 in order to aid in Non-Owner Authentication with the End Agent.

Only Non-Owner Authentication requires Centralization: Upon Non-Owner Authentication with their Authenticator End Agent verifies Authentication Factors with an Authentication Server 007.

This Decentralizes Ownership Authentication Management, while enabling any Non-Owner Interested Agent (such as 013) to Authenticate with their own Authenticator End Agent (such as 014) on any Non-Authenticator End Agent (such as 012), so long as their Semantics match and access to the non-Owner Authentication Server is possible. No Authenticator needs to be represented on the Central Server.

This enables Non-Owner Interested Agents (such as 013, 018, 025, and 026) to Authenticate and interact freely with End Agents (such as 015, 020, 023, and 012) that allow those Sub-Classifications as determined by their respective Owners (such as 017, 021, 026 and 011), without Centralization of Ownership Management.

If, during Non-Owner Authentication, there is no route to the Authentication Server, Non-Owner Authentication is not possible.

The Owner 009 of the Network Server 007 cannot gain access to Authenticators on the Network because they are not represented on the Network Server. Only the Network Server 007 Owner 009 has an Authenticator 008 that is represented on the Network, as the Network Server is just another End Agent on the Network that requires its own Authentication.

In this Decentralized Model, a Non-Owner Interested Agent (such as 018) can Authenticate on two End Agents (such as 015 and 020) synchronously or asynchronously.

In this Decentralized Model, two Non-Owner Interested Agents (such as 025 and 026) can Authenticate on a single End Agent (such as 023) synchronously or asynchronously.

In this Decentralized Model, an Owner Interested Agent (such as 028) can choose not to represent their End Agent(s) (such as 030 or 031) on the Network, but this would prohibit other Non-Owner Interested Agents to ever Authenticate with non-network End Agents. However, the Owner can still make use of an Authenticator (such as 029) to streamline their management of their End Agents, and to potentially link those End Agents to the wider Network at some point in the future.

A drawback of this Decentralized Model is that if during Non-Owner Authentication no connection can be establishes to Authenticate the Non-Owner's Authenticator, Authentication is not possible. It also requires a Central Server for Non-Owner Authentication.

In a Distributed Authentication network 028, there is no requirement for a central server to aid in the Non-Owner Authentication Management of an End Agent. Instead, End Agents can verify Non-Owner Authentication factors through other Non-Authenticator End Agents 030, including potentially an Authentication Server 029, but also without an Authentication Server 029. Multiple End Agents can be queried as part of the Authentication Process 030. Owners (such as 033) can chose which End Agents or network of End Agents or Sub-Network of End Agents their End Agents seek Distributed Authentication Factors from.

In this Distributed Authentication Model 028, if during Non-Owner Authentication, one route to establishing Authenticating Factor Trust is interrupted (such as 031), other routes can be utilized (such as 032).

An advantage to this Distributed Authentication Model is that multiple routes to multiple Authentication server records can be utilized to establish Non-Owner Authentication, with no centralization required. Furthermore, all the advantages and features in Decentralized Authentication Model apply, without the disadvantages of any form of Centralization.

In both Decentralized 006 and Distributed 028 Networks of Cyber Physical Systems, establishing Ownership and Non-Ownership Trust via an Authenticator Apparatus require 1) a Semantic Data Model for Agency sub-classification and services classification and sub-classification, 2) the definition of an End Agent State Machine, and 3) the definition of a set of 9 distributed ownership and non-ownership authentication processes.

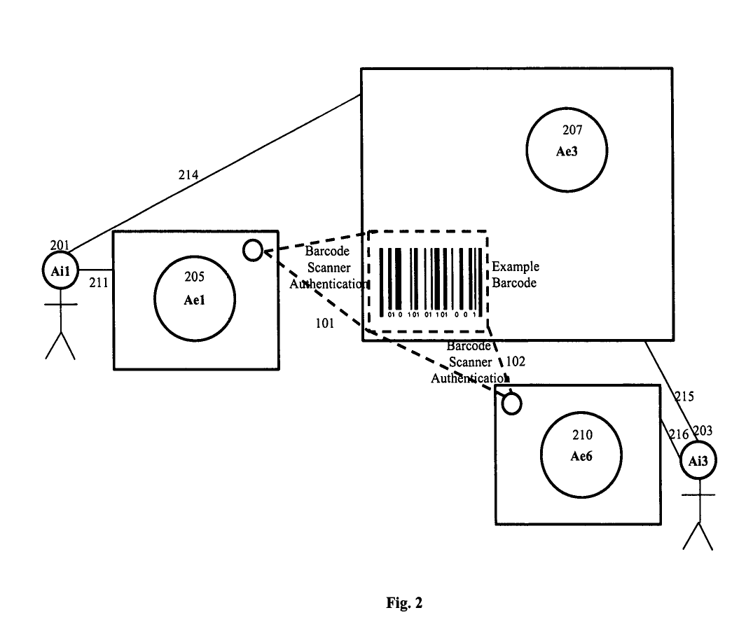

FIG. 2 shows two distinct authentication processes (101 and 102) showing the interplay between multiple Interested Agents, multiple Authenticators, and a non-Authenticator End Agent, with Utility Services, Ownership and Semantic Data Model management throughout.

In 101, Interested Agent Ai1 201 owns Authenticator End Agent Ae1 205. In the first process 101, Interested Agent Ai1 201 is served Utility by Authenticator End Agent Ae1 205 pre-registers and Authenticates Non-Authenticator End Agent Ae3 207 (represented in this example as the Authenticator End Agent Ae1 205 scanning a barcode on the Non-Authenticator End Agent Ae3 207). At this time, Authenticator End Agent Ae1 205 records Ownership 214 of Ae3 207 by Ai1 201.

In 102, Interested Agent Ai3 203 owns Authenticator End Agent Ae6 210. In the second process 102, upon Authentication of Non-Authenticator End Agent Ae3 207 with Authenticator End Agent Ae6 210, Interested Agent Ai3 203 is Served Utility 215 by Non-Authenticator End Agent Ae3 207, while Ownership 214 of Ae3 207 is maintained by Ai1 201 (Authentication represented in this example as the Authenticator End Agent Ae6 210 scanning a barcode on the Non-Authenticator End Agent Ae3 207).

This Figure Assumes that after authentication of Ownership of Ae3 207 by Ai1 201, Owner Ai1 201 Utilizes Authenticator Ae1 205 to determine the Semantic Data Model of End Agent Ae3 207, to include allowing the non-specified Sub-Classification of Interested Agent Ai3 203 to be capable of Authenticating 102 with Ae3 207.

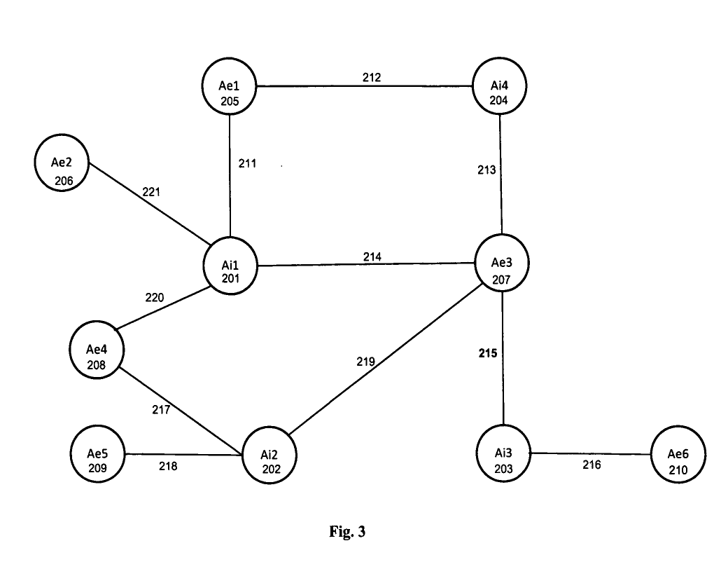

FIG. 3 shows the portion of the Semantic Data Model of Devices/Apparatuses (Classified as “Ed Agents” or by the nomenclature “Ae”) that defines their Relationship (or “Utility”) with non-Device/non-Apparatus agents (Classified as “Interested Agents” or by the nomenclature Ai) in an example Network of Cyber Physical Systems.

Ai1 201 is an Interested Agent that Owns 211 an Authenticator End Agent Ae1 205, Owns 221 an un-specified Sub-Classification End Agent Ae2 206, and Owns 214 an un-specifies Sub-Classification End Agent Ae3 207. Another Interested Agent Ai2 202 then owns 219 Ae3 207 after ownership is transferred by Ai1 201.

Ae3 207 was pre-registers and Authenticated 213 by non-Owner Interested Agent Ai4 204 wen Ai1 201 Distributed 212 their Authenticator Ae1 205 to Ai4 204 for this purpose.

Ae4 208 is an Authenticator End Agent that was Pre-Registered and Authenticated 220 by Ai1 201. Ai2 202 is an Interested Agent that then Owns 217 Ae4 208 after ownership is transferred by Ai1 201.

Ai2 202 Owns 218 an additional Authenticator End Agent Ae5 209. Ai3 207 is Served Utility 215 by Ae3 207 on Authentication but does not Own Ae3 207.

Ai3 203 is an Interested Agent that Owns 216 an Authenticator End Agent Ae6 210.

Ai3 203 has an un-specified Sub-Classification of Interested Agency that matched an Authetnicatable Sub-Classification on the End Agent Ae3 207 as defined in the End Agents (Ae3 207) Semantic Data Model. The Semantic Data Model of Ae3 207 is defined by Owner Interested Agent Ai1 201 after it is pre-registered and authenticated, and the Semantic Data Model transfers with the End Agent Ae3 207 when its ownership is transferred to Ai2 202 by Ai1 201.

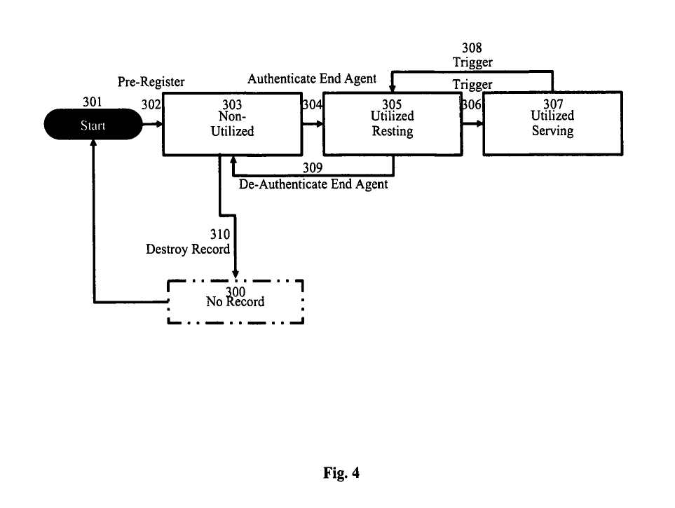

FIG. 4 shows an End Agent State Machine for both Authenticators and Non-Authenticators that is a representation of the minimum possible states and transitions of any End Agent in this invention.

If an End Agent has no record, having either never been Pre-Pre-Pre-Registered of having had every instance of its Registration Destroyed in the Network, it logically has 300 No Record.

To start 301 its Life, an End Agent must first be Pre-Pre-Registered 302 by an Authenticator.

Pre-Registration, defines at a minimum, the unique identification record of End Agent Semantic Data Model, Ownership is inherited from the Utilized Authenticator. One Pre-Pre-Registered, the End Agent is in Non-Utilized 303 State. At a minimum, no new data is required for the Semantic Data Model of the Non-Utilized End Agent, and no Services can be Triggered, in this Non-Utilized State 305 state.

An Authenticator matching the Owner of the Pre-Pre-Registering Authenticator can Authenticate 304 the End Agent—upon Authentication, the End Agent is in Utilized Resting 305 State.

An infinite array of Semantic Data Model (sub-classes, services, triggers, content, etc) can be defined by an Authenticator matching the Owner of the Utilized Resting End Agent.

Services can be triggered when the End Agent is in Utilized Resting, although Services cannot be provisioned when the End Agent is in this Utilized Resting State.

An End Agent can be Triggered 306 through Authentication by matching the Sub-Classification of Interested Agent to the Semantic Data Model sub-classifications defined by the Owner of the End Agent.

Upon Triggering, the End Agent is in the Utilized Serving 307 state. An End Agent can provision services in this Utilized Serving State.

An End Agent can be Triggered 308 in this Utilized Serving State to stop provisioning services, returning the End Agent to Utilizing Resting 305 state.

An End Agent can be De-Authenticated 309 by an Authenticator matching the Owner of the End Agent. When De-Authenticated, the End Agent is in Non-Utilized 303 state, does not lose its Ownership, but can have its Sub-Classification removed.

If the End Agent is an Authenticator, it can only have its Sub-Class as an Authenticator removed if the Authenticator has no Utility relationships with any other End Agent.

An End Agent can have its Record Destroyed 310 by an Authenticator that matches the Owner of the End Agent if it is in Non-Utilized 303 state, and therefore is in “No Record’ 300 state.

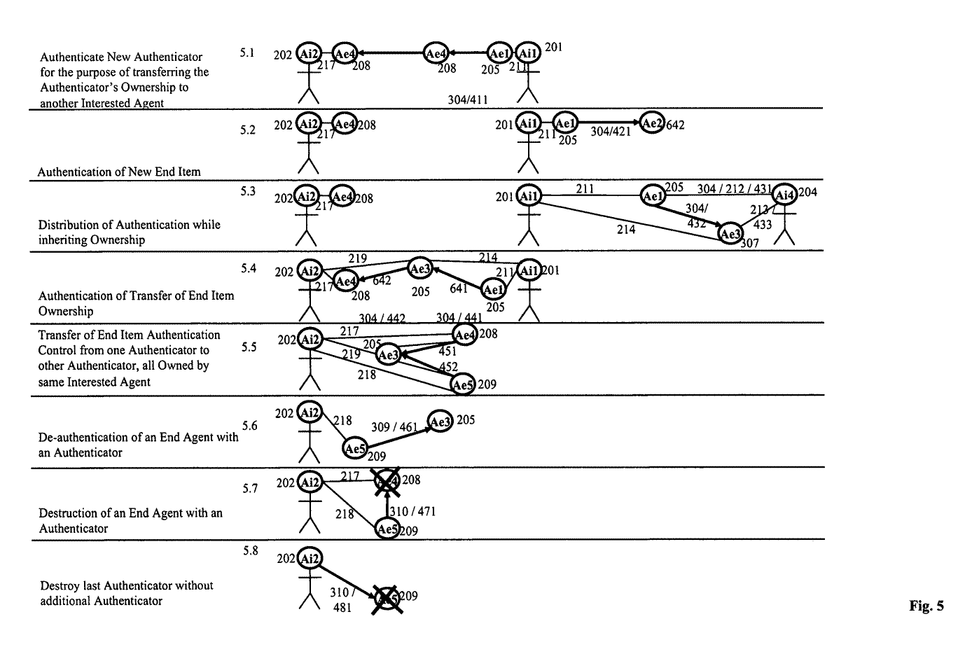

FIGS. 5.1, 5.2, 5.3, 5.4, 5.5, 5.6, 5.7, and 5.8 show how the Semantic Data Model of Agency between Owner and Non-Owner Interested Agents, and Authenticator and Non-Authenticated End Agents, and Sub-Classifications of Non-Owner Interested Agents, and the End Agent State Machine, and End Agent Authentication Services and Triggers and other Semantic Data, come together in a set of integrated and distributed Authentication processes that enable a Network of Cyber Physical Systems.

In FIG. 5.1, Interested Agent Ai1 201 Utilizes their Authenticator Ae1 205 to Authenticate 304 a transfer 411 Ownership 217 their Authenticator End Agent Ae4 208 to Interested Agent Ai2 202. This enables Interested Agent Ai2 202 to begin authenticating End Agents of their own.

In FIG. 5.2, Interested Agent Ai1 201 utilizes their 211 Authenticator Ae1 205 to Authenticate 304 Un-Specified Sub-Class End Agent Ae3 402, noting that the previously transferred Authenticator Ae4 208 inherits no ownership in the Authenticating Process 421.

In FIG. 5.3, Interested Agent Ai1 201 Distributes their Authenticator Privileges of Authenticator End Agent Ae1 205 (which is owned 211 by Ai1 201), to Ai4. This involves the Authentication 304 of the Distribution 431 of the Authenticator Ai1 201 establishing the temporary control 212 if Interested Agent Ai1 201. Next, the Interested Agent Ai4 204 Utilizes the Authenticator Ae1 205 to Authenticate 304/432 the new End Agent Ae3 307 with Ownership 214 inherited by the Authenticator Owner Ai1 201—this Authentication 304/432 by Ai4 204 “on behalf of” Ai1201 is distinct from the Authentication in FIG. 5.2 because the operation of the Authentication is by a “3^{rd} party” Interested Agent to the Owner Interested Agent. The Utility 213 between Interested Agent Ai4 204 and End Agent Ae3 307 is removed 433 once the Authenticator Ae1 205 is Redistributed to its Owner Ai1 201.

In FIG. 5.4, Interested Agent Ai1 201 Utilizes their 211 Authenticator Ae1 205 to transfer 641 their Ownership 214 of End Agent Ae3 205 to Interested Agent Ai2 202. Interested Agent Ai2 202 Utilizes their 217 Authenticator Ae4 208 to Confirm 642 the Transfer of End Agent Ae3 205, establishing the Ownership 219 between End Agent Ae3 205 and Interested Agent Ai2 202.

In FIG. 5.5, Interested Agent Ai2 202 Utilizes their 217 Authenticator Ae4 208 to Transfer 451 the Authentication of End Agent Ae3 205 from Authenticator Ae4 208 to Authenticator Ae5 209, and confirms 452 the Transfer with Authenticator Ae5 209. In this case, all three End Agents retain their respective Ownerships to Owner Ai2 202: 217, 218, and 219.

In FIG. 5.6, Interested Agent Ai2 202 Utilizes their 218 Authenticator Ae5 209 to De-Authenticate 309/461 their End Agent Ae3 205.

In FIG. 5.7, Interested Agent Ai2 202 Utilizes their 218 Authenticator Ae5 209 to destroy 310/471 their 217 Authenticator Ae4 208, eliminating as well Ownership 217.

In FIG. 5.8, Interested Agent Ai2 202 Destroys their only 310/481 Authenticator Ae5 209.

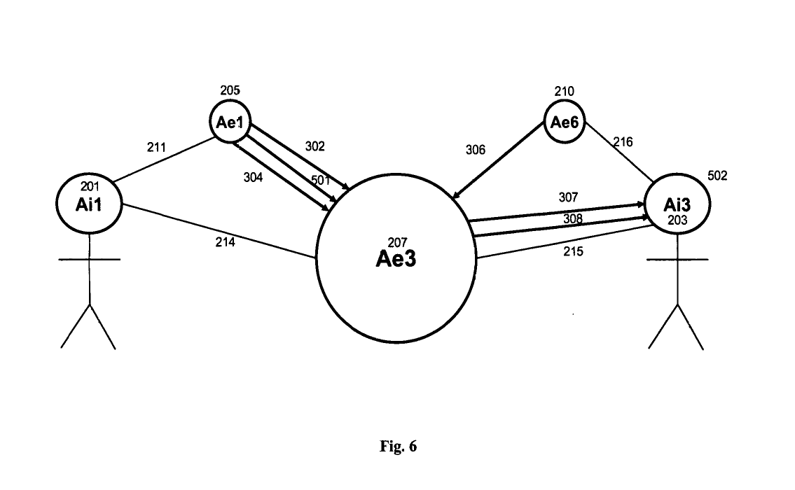

FIG. 6 shows how a Network of Cyber Physical Systems with distributed Trust between Agents enables an Interested Agent to Authenticate with, and be served by, an End Agent that is Owned by another Interested Agent.

Interested Agent Ai1 201 Owns 211 Authenticator End Agent Ae1 205. Interested Agent Ai1 201 Utilizes their Authenticator End Agent Ae1 205 to pre-register 302 and Authenticate 304 End Agent Ae3 207, establishing Ownership 214. Owner Ai1 201 then sets the Semantic Data Model of Ae3 207, including the Sub-Classifications of Interested Agents who may Authenticate with Ae3 207 to receive Services from Ae3 207. Ai1 201 may identify a specific person Sub-Classification or more broadly a group of people who self-identify their Sub-Classification. Interested Agent Ai3 203 independently Sub-Classifies themselves using their own 216 Authenticator Ae6 210. This invention does not specify the means of an Interested Agent Authenticating their Sub-Classification, but examples could include holding an Email Address with a particular Domain, participating in an Airline Miles Program, Owning a clothing item, physically being present with the End Agent, or any other elemental designation in an infinite array of Sub-Classifications. If he Sub-Classification of the Interested Agent Ai3 203 matches the Semantics Data Model set by the Ai1 201 for End Agent Ae3 207, Interested Agent Ai3 203 may trigger 306 with Ae3 207 using their Authenticator Ae6 210, establishing a temporary Utility 215 between Ai3 203 and Ae3 207. Ae3 207 will provide service 307 until triggered to stop providing Service 308. At no point will Ai3 203 be able to seize Ownership of Ae3 207, and the Services that Ai3 203 receive will only be those that are defined by Owner Ai1 201 in the Semantic Data Model of Ae3 207.

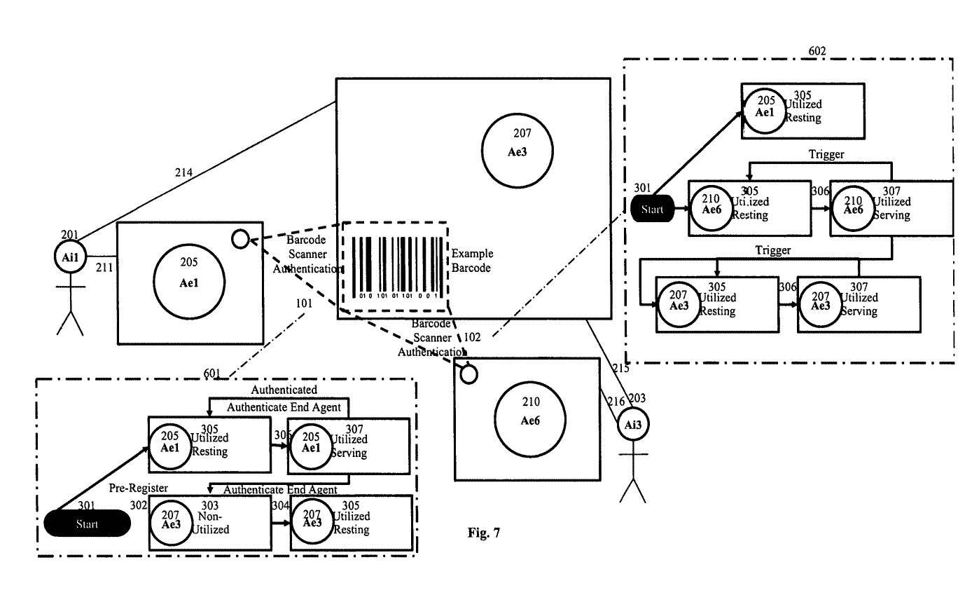

FIG. 7 shows the relationship between the End Agent State Machine in a Pre-Registration and Authentication, and an Authentication and Trigger set of Utilize cases.

Upon Bar Code Scanner Authentication (as an example) 101, the State Machines of the Relevant End Agents are altered 601, acting as a Trigger 306, Authenticator End Agent Ae1 205 goes from Utilizing Resting 305 to Utilized Serving 307 and pre-registers 302 End Agent Ae3 207. End Agent Ae3 207 is now in Non-Utilized State 303 and Ownership 214 is established between Ae1 201 and Ae3 207. Next, with or without a second bar code scan, the Authenticator End Agent Ae1 205 (or another End Agent that Ai1 Owns) again goes from Utilized Resting 305 to Utilized Serving 307 as it Authenticates 304 End Agent Ae3 207, which goes from Non-Utilized 303 to Utilized Resting 305. The Owner Ai1 201 can now se the Semantic Data Model of End Agent Ae3 207. Upon Bar Code Scanner Authentication (as an example) 102, the State Machines of relevant End Agents are altered 602, acting as a Trigger 306 on Authenticator Ae6 210, which goes from Utilized Resting 305 to Utilized Serving 307, which leads to End Agent Ae3 207 to then be triggered 306 from Utilized Resting 305 to Utilized Serving 307. Authenticator Ae1 205 does not change States.

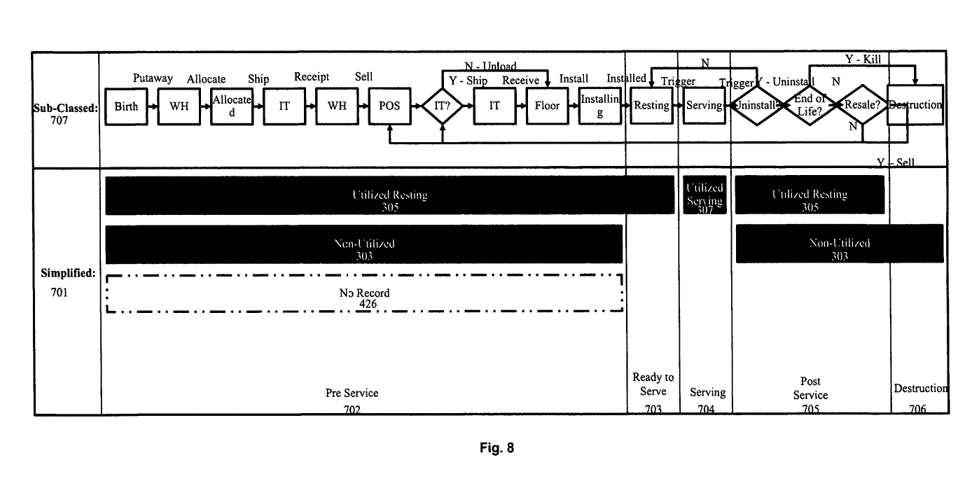

FIG. 8 shows how a Network of Cyber Physical Systems can have infinitely defined State Machine Sub-Classifications based on the End Agent State Machine defined in this Invention.

The Simplified 701 State Classifications can be further defined with Sub-Classifications that correspond to Pre-Service 702, Ready to Serve 703, Serving 704, Post Service 705, and Destruction 706. These example Sub-Classifications can be defined in an infinite array as a part of an End Agent's Semantic Data Model and be driven by various events. However, an End Agent Must be Authenticated before it can be considered Ready to Serve, and it must be Pre-Registered before its Service can be defined in the Semantic Data Model. However, utilizing this method of Sub-Classification, an End Agent's Authentication for management and utilization purposes can be established as early as its Birth Record.

What is claimed is:

1. A method and Apparatus for Establishing Multi-Agent Authentication in a decentralized or distributed network of cyber-physical systems.

2. The method of claim 1, further compromising of an Internet-Connected Device Authentication Process that manages Owners and Non-Owners in a Decentralized or Distributed Network of Agents with the aid of an Authenticator that is not directly connected to the internet, but instead interfaces with other Internet-Connected Devices.

3. The method of claim 1, further comprising of an Internet-Connected Device Authentication Process that understands between the owner of a Device, and a Non-Owner of that device.

4. The method of claim 1, consisting of a Data Model for a Network of Cyber-Physical Systems that treats devices and non-devices as “Agents”, and classifies device Agents as “End Agents” and non-device Agents as “interested Agents.”

5. The method of claim 1, wherein the Data Model for a Decentralized or Distributed Network of Cyber Physical Systems defines a Sub-Classification of End Agents as an “Authenticator.”

6. The method of claim 1, wherein the Data Model for a Decentralized or Distributed Network of Cyber Physical Systems defines a Sub-Classification of Interested Agent as “Owner”.

7. The method of claim 1, wherein the Data Model for a Decentralized or Distributed Network of Cyber Physical Systems defines a Utility Relationship between an Interested Agent and an End Agents that they are said to be the “Owner” as a function of their Utility.

8. The Apparatus of claim 1, wherein an End Agent State Machine that applies to both Authenticator and Non-Authenticator End Agents as a function of Pre-Registration, Authentication and Service Delivery.

9. The Apparatus of claim 1, comprising of an Authentication Process by an existing Authenticator of a new Authenticator for the purpose of Transferring Ownership of the new Authenticator to another Interested Agent.

10. The Apparatus of claim 1, comprising of an Authentication Process by an Authenticator of a new End Agent for its Owner.

11. The method of claim 1, wherein a Distributed Authentication Process whereby an Owner of an Authenticator can give their Authenticator to another Interested Agent who can Authenticate New End Items “on behalf or the Authenticator's Owner and whereby Ownership is Inherited by the Owner and not the Interested Agent receiving the Authenticator.

12. The method of claim 1, comprising of an Authentication Process for an Owner to Transfer Ownership of an End Agent to another Owner.

13. The method of claim 1, comprising of an Authentication Process for Transferring an Authentication Record from one Authenticator to another Authenticator when all three End Agents are owned by the same owner.

14. The method of claim 1, compromising of a De-Authentication Process of an End Agent by their Owner with the Authenticator holding the Authentication Record.

15. The method of claim 1, compromising of a De-Authentication Process of an Authenticator with another Authenticator.

16. The method of claim 1, compromising of a De-Authentication Process of an Authentication that has no Authentication Records.

17. The method of claim 1, compromising of an Authentication process that allows Owners of End Agents to Specify any defined Sub-Class of Interested Agent that is able to Authenticate on the Owner's End Agent, and be served by that End Agent, without giving the ability for the Non-Owner Interested Agent to take Ownership or Full Control themselves.

18. The method of claim 1, comprising of the ability for the State Machine's States to be split into Sub-Classified States.

19. The method of claim 1, compromising of a trust or Authorization chain that can continue to grow given the method and apparatus of authorization that is stored on a disconnected Apparatus (Authenticator).

20. The method of claim 1, comprising of a trust or authorization chain that can continue to grow given the method and apparatus of authorization that is partially or fully broadcast when authorizations occur.

21. The method of claim 1, wherein there is a method for identifying an Interested Agent sub-classification and ownership status based on transmission between Non-Authenticators Devices and Authenticator Devices.
